(19) United States
(12) Patent Application Publication
(10) Pub. No.: US 2005/0017845 A1
(43) Pub. Date: Jan. 27, 2005

(54) Tagging and tracking system

(76) Inventor: Mark Honore Shellans, Black Forest, CO (US)

Correspondence Address: Law Office of Dale B. Halling, LLC, Suite 311, 24 South Weber St., Colorado Springs, CO, 80903, US

(21) Appl. No.: 10/624,661

(22) Filed: Jul. 22, 2003

(51) Int. Cl. H04Q 5/22; G08B 5/22

(52) U.S. Cl. 340/10.4; 340/825.49

(57) ABSTRACT

A tagging and tracking system includes an electromagnetic transmitter having an output. A modulating tag embeds an information signal on a reflection of the output from the electromagnetic transmitter. The modulating tag includes a tamper proof system. A receiver receives the reflection with the information signal. The receiver has a received output. A processor is coupled to the received output for decoding the information signal.

### FIELD OF THE INVENTION

The present invention relates generally to the field of electronic systems and more particularly to a tagging and tracking system.

### BACKGROUND OF THE INVENTION

Every vehicle in the United States of America is given a unique license tag. These tags were originally issued as part of a system to reduce vehicle theft. In recent years these tags have been helpful in solving a variety of other crimes. When a vehicle is used in a crime, witnesses are able to report the license tag number to the authorities. The authorities enter the license tag number in a database and add information about the crime. When an officer stops a vehicle, he radios in the license tag to determine if the vehicle has been involved in a crime. As a result, the officer can only screen a few cars for involvement in a crime and the officer has to manually read the car's license tag. In addition, the officer does not have any way to determine if the license tags have been altered.

Thus there exists a need for a tagging and tracking system that does not require an officer to manually read a license tag number and then call the tag number into a central office to determine if the car has been used in a crime.

### SUMMARY OF INVENTION

A tagging and tracking system that overcomes these and other problems includes an electromagnetic transmitter having an output. A modulating tag embeds an information signal on a reflection of the output from the electromagnetic transmitter. The modulating tag includes a tamper proof system. A receiver receives the reflection having the information signal. The receiver has a received output. A processor is coupled to the received output and decodes the information signal. In one embodiment, a database is coupled to the processor.

In one embodiment, the information signal is a periodic signal. In another embodiment, the information signal is modulated at a frequency higher than a probable Doppler shift. The information signal is a polarization modulated signal in one embodiment.

In another embodiment, the modulating tag has a battery for power. The modulating tag may include an integrated circuit that drives a plurality of switches that create the information signal. In one embodiment, a tagging and tracking system has a number of modulating tags. Each of the tags are attached to a mobile unit. A number of electromagnetic transmitters are positioned in a number of key locations. A number of receivers are associated with the transmitters. A receiver receives a reflected signal from one of the modulating tags. A database is coupled to the receivers and compares the reflected signal to a predetermined signal. In one embodiment, the reflected signal is a phase modulated signal. In another embodiment, the reflected signal defines a unique identifier for one of the modulating tags. In one embodiment, the database contains an associated group of information related to the unique identifier.

The mobile units may be motor vehicles. In one embodiment, the modulating tags are license tags. In one embodiment, the key locations are traffic choke points in a city.

In one embodiment, a tagging and tracking system includes a number of modulating tags each capable of modulating a polarization of a received signal. The modulating tags are attached to a number of mobile units. An electromagnetic transmitter has an output capable of being pointed at one of the modulating tags. An electromagnetic receiver receives a reflected signal from one of the modulating tags. A processor uniquely identifies the modulating tag. In one embodiment, a database is coupled to the processor. The database contains information associated with the modulating tags. In one embodiment, a modulating tag has been tampered with and reflects a tampered signal.

In one embodiment, the modulating tag has a tamper proof system. The information signal is a periodic signal. The information signal has a frequency that is higher than a probable Doppler shift.

### BRIEF DESCRIPTION OF THE DRAWINGS

FIG. 1 is a block diagram of a tagging and tracking system in accordance with one embodiment of the invention;

FIG. 2 is a block diagram of a modulating tag in accordance with one embodiment of the invention;

FIG. 3 is a graph of a spectrum of the transmitted signal, the Doppler shifted signal and the information signal in accordance with one embodiment of the invention;

FIG. 4 is a graph of the periodic information signal in accordance with one embodiment of the invention;

FIG. 5 is a carton drawing of tagging and tracking system in accordance with one embodiment of the invention; and

FIG. 6 is a block diagram of a tagging and tracking system in accordance with one embodiment of the invention.

### DETAILED DESCRIPTION OF THE DRAWINGS

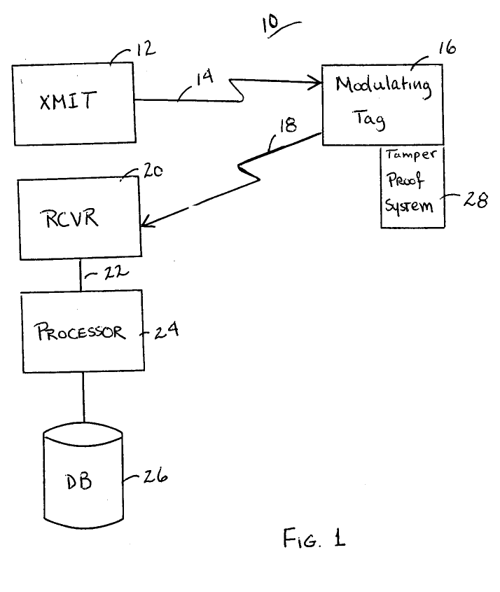

FIG. 1 is a block diagram of a tagging and tracking system 10 in accordance with one embodiment of the invention. The system includes an electromagnetic transmitter 12 having an output 14. The output 14 impinges on a modulating tag 16. The modulating tag 16 modulates the reflected signal 18 to form an information signal. An electromagnetic receiver 20 receives the reflection containing the information signal. A received output 22 is coupled to a processor 24. The processor 24 decodes the information signal. In one embodiment, the information signal uniquely defines the modulating tag 16. The unique ID may be used to retrieve information from a database 26. For instance, the unique ID may be used to find out that the vehicle associated with the tag 16 was used in a robbery. In one embodiment, the modulating tag 16 includes a tamper proof system 28. The tamper proof system 28 prevents an unscrupulous person from altering the information signal or moving the tag to another vehicle. One application of the system 10 is to replace present license tags with modulating tags 16. The transmitter 12 and receiver 20 in that embodiment may be a standard police radar system. The processor 24 may be the microprocessor in a portable computer the police have in their vehicles. The database 26 may be a standard database stored on the portable computer. The database may be updated by a storage medium or may be updated by transmitting the information over a police radio band. The system may also be used to track boats, planes, railroad cars or just about any other mobile object.

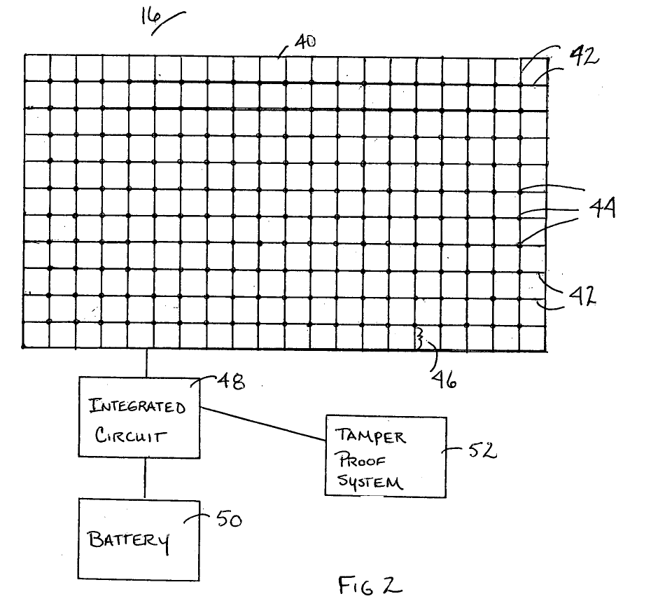

FIG. 2 is a block diagram of a modulating tag 16 in accordance with one embodiment of the invention. The modulating tag 16 includes flat frame 40 having a plurality of conductive traces 42 thereon. The plurality of conductive traces 42 are connected together by electronic switches (plurality of switches, plurality of electrical switches) 44. The switches 44 are shown as dots. The length 46 of the traces 42 between the switches 44 is an antiresonance length of the search electromagnetic wave. When the switches are closed the surface 40 is reflective to the search electromagnetic wave and when the switches are open the surface 40 is not reflective (less reflective, reflective properties) to the search electromagnetic wave. By alternatively opening and closing the switches the reflected signal of the search electromagnetic wave is modulated in amplitude. This modulation can then be detected by a receiver. Note that in one embodiment, the switches 44 are replace by veractor diodes. In another embodiment, the switches are MEMS (Micro Electro-Mechanical Systems). However, the operation and principle is essentially unchanged.

In another embodiment the surface 40 includes a plurality of conductive traces that form a plurality of polygons. The plurality of polygons each have a smallest distance greater than a first predetermined distance. Note the smallest distance for a square would be the length of one side, while the length of the smallest distance for a rectangle would be the shorter of the two legs. This allows the surface 40 to reject signals that have a wavelength around the first predetermined distance and larger. In another embodiment the reflective surface 40 has a plurality of conductive traces that form a plurality of second polygons. The plurality of second polygons have a second smallest distance smaller than the first predetermined distance and greater than the second smallest distance. This allows the reflective surface to reflect electromagnetic waves having a wavelength around the second smallest distance or greater, but not reflect electromagnetic waves much smaller than the second smallest distance. Using this technique it is possible to select the wavelengths that will be reflected.

The switches 44 are controlled by an integrated circuit 48. The integrated circuit 48 is powered by a battery 50 in one embodiment. In one embodiment, the battery 50 and the integrated circuit 48 are combined. The owner of the vehicle periodically replaces the battery and the attached integrated circuit in a snap-in slot. A tamper proof system 52 is coupled to the integrated circuit 48. When the tamper proof system 52 detects any tampering it directs the integrated circuit 48 to change the information signal to a tampered signal. The tamper proof system 52 may use a simple continuity test. When someone attempts to tamper with the tag, a connection is broken. The tamper proof system 52 then knows that there has been an attempt to tamper with the tag. Other detection systems may be used by the tamper proof system 52, such as entry codes and encryption systems.

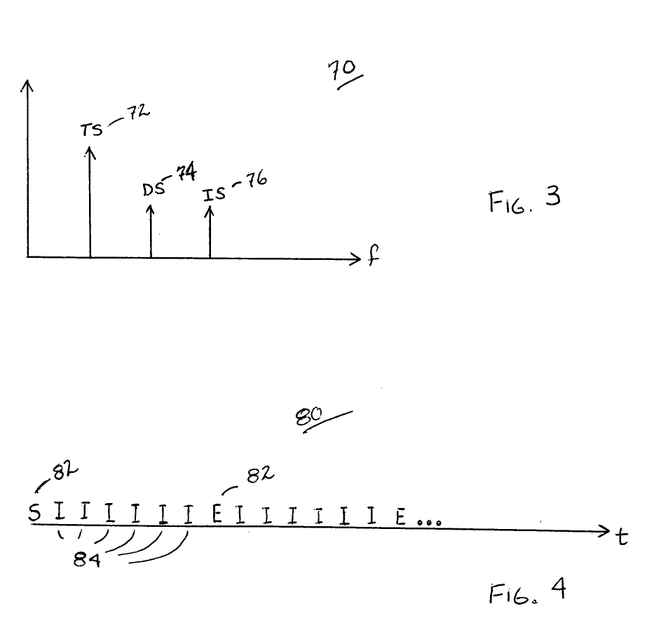

FIG. 3 is a graph of a spectrum 70 of the transmitted signal 72, the Doppler shifted signal 74 and the information signal 76 in accordance with one embodiment of the invention. The transmitted signal 72 is essentially a single frequency signal in one embodiment. The maximum probable Doppler shift might correspond to a speed of two hundred miles per hour. The information signal 76 is purposely given a frequency that is higher than the maximum probable Doppler shift. The information signal would also have mirror image below the Doppler shift, however this signal is not shown since it is not the preferred signal. The information signal may be amplitude, frequency or phase modulated. While this figure illustrates the case of a continuous wave transmitter, a pulsed or chirped transmitter may also be used.

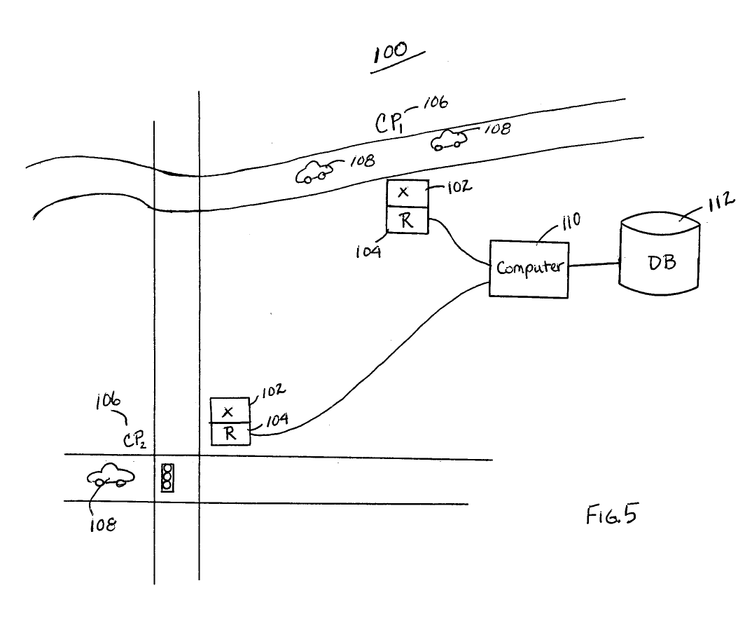

FIG. 4 is a graph of the periodic information signal 80 in accordance with one embodiment of the invention. The information signal 80 is periodic or cyclical since it is impossible to tell when the modulating tag will be illuminated. The signal 80 has a start bit or slot 82 followed by a number of information slots 84 and then an end bit 82. Note that the end bit or slot 82 may be the same as the start bit 82. In one embodiment, the information signal is a FSK-4 (Frequency Shift Keying) modulation. The start bit is one frequency and each slot represents two bits of information. This compresses the time necessary to send a unique ID. Many other modulation schemes can be used including FSK-16 and PN (Psuedo Noise).

FIG. 5 is a carton drawing of tagging and tracking system 100 in accordance with one embodiment of the invention. The system 100 has a plurality of electromagnetic transmitters (X) 102 and a plurality of electromagnetic receivers (R) 104 located at key locations throughout an area or city. The key locations are generally choke points 106 through which most of the traffic passes. A plurality of mobile units 108 each have a modulating tag. As the mobile units 108 move past the key locations 106 their modulating tags are illuminated by the transmitter 102. The reflected signal is detected by a receiver 104. The receivers 104 are coupled to a computer 110 that stores the unique identifier (ID) and associated information, such as date and time, in a database 112. This information can then be examined for likely suspects when a crime or terrorist event occurs nearby. In another embodiment, the computer can compare the unique identifier against known vehicles used in a crime and alert authorities when a match is found.

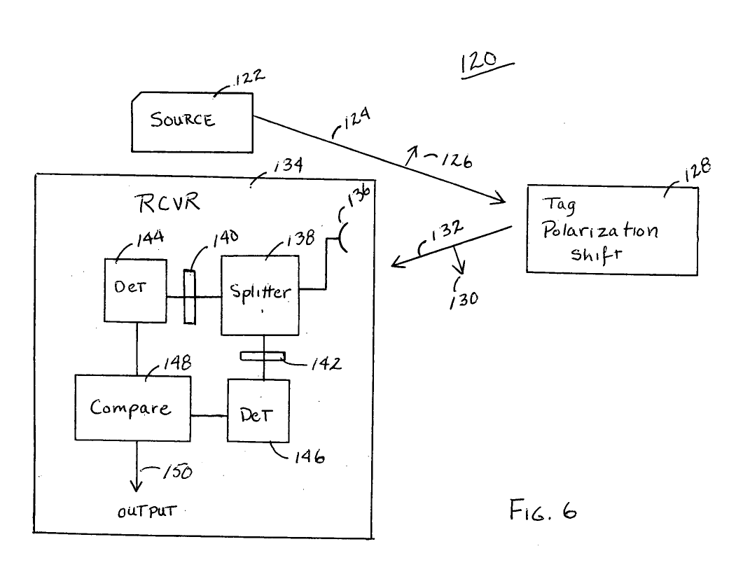

FIG. 6 is a block diagram of a tagging and tracking system 120 in accordance with one embodiment of the invention. This system 120 is similar to the system of FIG. 1 except that it uses the polarization of the reflected signal to carry the information. A source 122 transmits an electromagnetic wave 124 having a certain polarization 126. The electromagnetic wave impinges on the tag 128. The tag 128 alters the polarization 130 of the reflected wave 132. A receiver 134 has an antenna 136 connected to a splitter 138. The splitter 138 is connected to an x-polarization filter 140 and a y-polarization filter 142. Note in some embodiments the splitter 138 and filters are combined. For instance, a birefringent material will separate the x & y polarization of an optical signal. The x & y signals are detected by the detectors 144, 146. The magnitude of the x & y signals are compared by a comparator 148 and the output 150 provides the information. In one embodiment, the source 122 is an un-polarized signal 126 and the tag 128 selectively reflects either an x-polarized signal or a y-polarized signal. Or the signal can be carried as either a polarized reflection 132 or un-polarized reflection 132. In another embodiment, the source 122 transmits a circularly polarized 126 signal 124. The circularly polarized signal 126 is phase (polarization) shifted by the tag 128. The polarization phase shift may be accomplished by a number of devices in both the optical and microwave areas. In one embodiment, the phase shift occurs due to a change in the index of refraction of the tag 128. This phase shift in the polarization can be easily detected by the receiver 134.

Thus there has been described a tracking and tagging system that does not require an officer to manually read a license tag number and then call the tag number into a central office to determine if the car has been used in a crime.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A tagging and tracking system, comprising:
an electromagnetic transmitter having an output;
a modulating tag embedding an information signal on a reflection of the output from the electromagnetic transmitter, wherein the modulating tag includes a tamper proof system;
a receiver for receiving the reflection having the information signal, the receiver having a received output; and
a processor coupled to the received output for decoding the information signal.

2. The system of claim 1, further including a database coupled to the processor.

3. The system of claim 1, wherein the information signal is a periodic signal.

4. The system of claim 1, wherein the information signal is modulated at a frequency higher than a probable Doppler shift.

5. The system of claim 4, wherein the information signal is a polarization modulated signal.

6. The system of claim 1, wherein the modulating tag has a battery for power.

7. The system of claim 6, wherein the modulating tag includes an integrated circuit that drives a plurality of switches that create the information signal.

8. A tagging and tracking system, comprising:
a plurality of modulating tags each attached to one of a plurality of mobile units;
a plurality of electromagnetic transmitters positioned in a plurality of key locations;
a plurality of receivers, one of the plurality of receivers receiving a reflected signal from one of the plurality of modulating tags; and
a database coupled to the plurality of receivers comparing the reflected signal to a predetermined signal.

9. The system of claim 8, wherein the reflected signal is a phase modulated signal.

10. The system of claim 8, wherein the reflected signal defines a unique identifier for one of the plurality of modulating tags.

11. The system of claim 10, wherein the database contains an associated group of information related to the unique identifier.

12. The system of claim 8, wherein the plurality of mobile units are motor vehicles.

13. The system of claim 12, wherein the plurality of modulating tags are each a license tag.

14. The system of claim 13, wherein the plurality of key locations are traffic choke points in a city.

15. A tagging and tracking system, comprising:
a plurality of modulating tags attached to a plurality of mobile units, each of the plurality of tags capable of modulating a polarization of a received signal;
an electromagnetic transmitter having an output capable of being pointed at one of the plurality of modulating tags;
an electromagnetic receiver receiving a reflected signal from one of the plurality of modulating tags; and
a processor uniquely identifying the one of the plurality of modulating tags.

16. The system of claim 15, further including a database coupled to the processor, wherein the database contains an information associated with the one of the plurality of modulating tags.

17. The system of claim 15, wherein one of the plurality of modulating tags has been tampered with and reflects a tampered signal.

18. The system of claim 15, wherein each of the plurality of modulating tags has a tamper proof system.

19. The system of claim 18, wherein the information signal is a periodic signal.

20. The system of claim 19, wherein the information signal has a frequency that is higher than a probable Doppler shift.
